(19) United States
(12) Patent Application Publication
(10) Pub. No.: US 2026/0141436 A1
(43) Pub. Date: May 21, 2026

(54) METHOD, APPARATUS, DEVICE, AND STORAGE MEDIUM FOR ITEM RECOMMENDATION

(71) Applicant: Beijing Zitiao Network Technology Co., Ltd., Beijing (CN)

(72) Inventors: Wei DONG, Beijing (CN); Jie MEI, Beijing (CN); Lizheng XIE, Beijing (CN); Guangxishui YANG, Beijing (CN); Bowen SHEN, Beijing (CN); Junan CHEN, Beijing (CN); Haiqing WANG, Beijing (CN); Xin SUN, Beijing (CN)

(21) Appl. No.: 19/314,557

(22) Filed: Aug. 29, 2025

(30) Foreign Application Priority Data
Nov. 19, 2024 (CN) 202411660931.4

(51) Int. Cl. G06Q 30/0601; G06N 20/00

(52) U.S. Cl. CPC G06Q 30/06311; G06N 20/00

(57) ABSTRACT

According to embodiments of the disclosure, a method, an apparatus, a device, and a storage medium for item recommendation are provided. A method includes: obtaining activity information of a target user within a target time period, the activity information being related to at least one type of interaction activity performed by the target user within the target time period, and a participation degree of the target user in the at least one type of interaction activity satisfying a preset condition; recognizing one or more target items associated with the target user by using a machine learning model and based on the activity information and sample information of the at least one type of interaction activity; and presenting recommendation information about the one or more target items.

### CROSS-REFERENCE

The present application claims priority to Chinese Patent Application No. 202411660931.4, filed on Nov. 19, 2024, and entitled “METHOD, APPARATUS, DEVICE AND STORAGE MEDIUM FOR ITEM RECOMMENDATION”, which is incorporated herein by reference in its entirety.

### FIELD

Example embodiments of the present disclosure generally relate to the field of computers, and in particular, to a method, an apparatus, a device, and a computer-readable storage medium for item recommendation.

### BACKGROUND

With the development of information technologies, various terminal devices may provide people with various services in aspects such as work and life. Applications that provide the services may be deployed in the terminal devices. How to use the terminal devices or the applications to provide more convenient services for users is a technical issue to be explored currently.

### SUMMARY

In a first aspect of the present disclosure, a method for item recommendation is provided. The method includes: obtaining activity information of a target user within a target time period, the activity information being related to at least one type of interaction activity performed by the target user within the target time period, and a participation degree of the target user in the at least one type of interaction activity satisfying a preset condition; recognizing one or more target items associated with the target user by using a machine learning model and based on the activity information and sample information of the at least one type of interaction activity; and presenting recommendation information about the one or more target items.

In a second aspect of the present disclosure, an apparatus for item recommendation is provided. The apparatus includes: an activity information obtaining module configured to obtain activity information of a target user within a target time period, the activity information being related to at least one type of interaction activity performed by the target user within the target time period, and a participation degree of the target user in the at least one type of interaction activity satisfying a preset condition; a target item recognition module configured to recognize one or more target items associated with the target user by using a machine learning model and based on the activity information and sample information of the at least one type of interaction activity; and a recommendation information presentation module configured to present recommendation information about the one or more target items.

In a third aspect of the present disclosure, an electronic device is provided. The device includes at least one processor; and at least one memory, the at least one memory being coupled to the at least one processor, and storing instructions executable by the at least one processor, the instructions, when executed by the at least one processor, causing the device to perform the method of the first aspect.

In a fourth aspect of the present disclosure, a computer-readable storage medium is provided. The computer-readable storage medium has a computer program stored thereon, the computer program being executable by a processor to implement the method of the first aspect.

It would be appreciated that the content described in the Summary section of the present disclosure is neither intended to limit key or essential features of embodiments of the present disclosure, nor is intended to limit the scope of the present disclosure. Other features of the present disclosure will be readily envisaged through the following description.

### BRIEF DESCRIPTION OF THE DRAWINGS

The above and other features, advantages, and aspects of embodiments of the present disclosure become more apparent with reference to the following detailed description and in conjunction with the drawings. In the drawings, the same or similar reference numerals denote the same or similar elements.

FIG. 1 illustrates a schematic diagram of an example environment in which embodiments of the present disclosure may be implemented;

FIG. 2 illustrates a flowchart of a method for item recommendation according to some embodiments of the present disclosure;

FIG. 3 illustrates a flowchart of an example process for item recommendation according to some embodiments of the present disclosure;

FIG. 4 illustrates a schematic structural block diagram of an apparatus for item recommendation according to some embodiments of the present disclosure; and

FIG. 5 illustrates a block diagram of a device capable of implementing a plurality of embodiments of the present disclosure.

### DETAILED DESCRIPTION

It would be appreciated that before the use of the technical solutions disclosed in the embodiments of the present disclosure, the user shall be informed of the type, range of use, use scenarios, etc., of user information involved in the present disclosure in an appropriate manner in accordance with the relevant laws and regulations, and the authorization of the user shall be obtained.

For example, in response to receiving an active request from a user, prompt information is sent to the user to clearly prompt the user that the requested operation will require access to and use of the user's information. As such, the user may independently choose, based on the prompt information, whether to provide the user information to the software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the user information to the electronic device.

The enabling of relevant functions, the data obtained, the manner in which the data is processed and stored, etc., in embodiments of the present disclosure shall all be authorized in advance by the user and other rights subjects associated with the user, and shall comply with the provisions of the relevant laws and regulations and agreement rules between the rights subjects.

It would be appreciated that before the use of the technical solutions disclosed in embodiments of the present disclosure, the relevant user shall be informed of the type, range of use, use scenarios, etc., of information involved in the present disclosure in an appropriate manner in accordance with the relevant laws and regulations, and the authorization of the relevant user shall be obtained. The relevant user may include any type of rights subject, such as an individual, a company, or a group.

For example, in response to receiving an active request from a user, prompt information is sent to the relevant user to clearly prompt the relevant user that the requested operation will require access to and use of the information of the relevant user. As such, the relevant user may independently choose, based on the prompt information, whether to provide the information to the software or hardware, such as an electronic device, an application, a server, or a storage medium, that performs the operations of the technical solutions of the present disclosure.

As an optional but non-limiting implementation, in response to receiving the active request from the relevant user, the prompt information may be sent to the relevant user in the form of, for example, a pop-up window, in which the prompt information may be presented in text. Furthermore, the pop-up window may also include a selection control for the user to choose whether to “agree” or “disagree” to provide the information to the electronic device.

It would be appreciated that the above process of notifying and obtaining user authorization is only illustrative and does not limit the implementations of the present disclosure, and other manners that satisfy the relevant laws and regulations may also be applied in the implementations of the present disclosure.

It would be appreciated that with the technical solution, the data involved (including but not limited to the data itself, acquisition, use, storage, and transmission of the data) shall comply with the requirements of the corresponding laws, regulations, and related provisions.

It would be appreciated that the above process of notifying and obtaining user authorization is only illustrative and does not limit the implementations of the present disclosure, and other manners that satisfy the relevant laws and regulations may also be applied in the implementations of the present disclosure.

The embodiments of the present disclosure will now be described in more detail with reference to the drawings. Although some embodiments of the present disclosure are shown in the drawings, it would be appreciated that the present disclosure may be implemented in various forms and should not be construed as limited to the embodiments set forth herein. Instead, these embodiments are provided for a thorough and complete understanding of the present disclosure. It would be appreciated that the drawings and embodiments of the present disclosure are only for illustrative purposes and are not intended to limit the scope of protection of the present disclosure.

It should be noted that the titles of any section/sub-section provided herein are not limiting. Various embodiments are described throughout this disclosure, and any type of embodiment may be included under any section/sub-section. Furthermore, the embodiments described in any section/sub-section may be combined with any other embodiments described in the same section/sub-section and/or different section/sub-section in any manner.

Herein, unless explicitly stated, performing a step “in response to A” does not mean that the step is performed immediately after “A”, but may include one or more intermediate steps.

In the description of the embodiments of the present disclosure, the term “include/comprise” and similar terms thereof should be understood as open-ended inclusions, that is, “include/comprise but not limited to”. The term “based on” should be understood as “based at least in part on”. The term “an embodiment” or “the embodiment” should be understood as “at least one embodiment”. The term “some embodiments” should be understood as “at least some embodiments”. Other explicit and implicit definitions may also be included below. The terms “first”, “second”, etc. may refer to different or same objects. Other explicit and implicit definitions may also be included below.

As used herein, the term “model” may learn the correlation between corresponding input and output from training data, so that after the training is completed, the corresponding output may be generated for a given input. The generation of the model may be based on machine learning techniques. Deep learning is a machine learning algorithm that uses multiple layers of processing units to process input and provide corresponding output. Herein, a “model” may also be referred to as a “machine learning model”, a “machine learning network”, or a “network”, which terms are used interchangeably herein. A model may include different types of processing units or networks.

### Example Environment

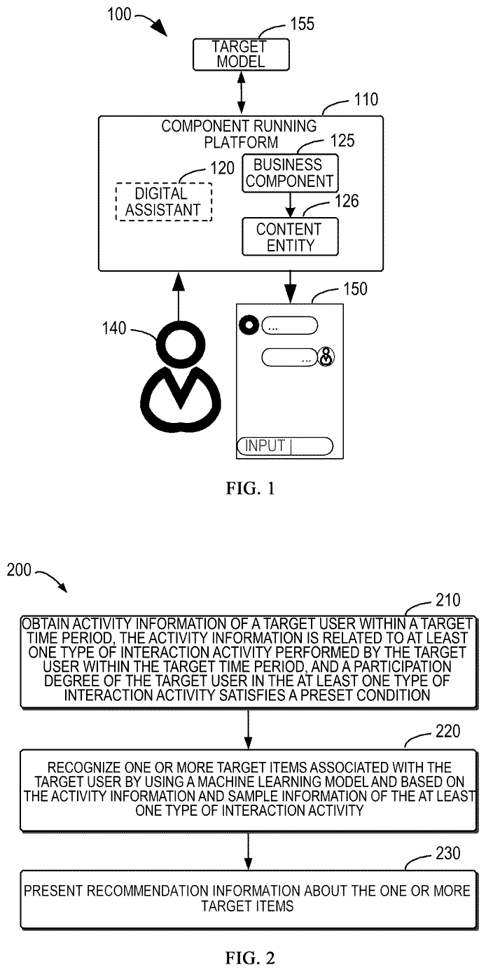

FIG. 1 illustrates a schematic diagram of an example environment 100 in which embodiments of the present disclosure may be implemented. In this example environment 100, a component running platform 110 may support the operation of a business component 125. A user 140 may interact with the business component 125 via a client of the component running platform 110.

In some embodiments, the business component 125 may be downloaded and installed on a terminal device of the user 140. In some embodiments, the business component 125 may also be accessed in other manners, such as via a web page. In the environment 100 of FIG. 1, the client of the component running platform 110 may present an interface 150 of the business component 125 in response to the business component 125 being launched.

The business component 125 includes, but is not limited to, one or more of: a chat business component (also referred to as an instant messaging (IM) business component), a document business component, an audio and video conference business component, an email business component, a task business component, a calendar business component, an objective and key results (OKR) business component, etc. It would be appreciated that although a single business component is shown in FIG. 1, multiple business components may actually be installed on the component running platform 110. The multiple business components may be integrated on the component running platform 110, and such a component running platform 110 may be regarded as a multifunctional collaboration platform. In the case that multiple business components are installed on the terminal device, the multiple business components may be integrated on one or more component running platforms 110. In the component running platform 110, people may launch different business components as needed to complete corresponding information processing, sharing, communication, etc. The business component 125 may provide a content entity 126. The content entity 126 may be a content instance created by the user 140 or other users on the business component 125. For example, depending on the type of the business component 125, the content entity 126 may be a document (e.g., a word document, a pdf document, a presentation document, a spreadsheet document, etc.), an email, a message (e.g., a chat message on the instant messaging business component), a calendar, a schedule, a task, an audio, a video, an image, etc.

In some embodiments, the component running platform 110 may provide a digital assistant 120. The digital assistant 120 may be provided by a separate business component, or may be integrated in a certain business component 125 that may provide a content entity. The business component for providing the client interface of the digital assistant may correspond to a single-function business component or a multifunctional collaboration platform, such as an office suite or other collaboration platforms that may integrate multiple components. It would be appreciated that, similar to the business component, although a single digital assistant is shown in FIG. 1, there may actually be multiple digital assistants.

In some embodiments, the digital assistant 120 supports the use of plugins. Each plugin may provide one or more functions of the business component. Such plugins include, but are not limited to, one or more of: a search plugin, a contact plugin, a message plugin, a document plugin, a spreadsheet plugin, an email plugin, a calendar plugin, a schedule plugin, a task plugin, etc.

The digital assistant 120 may be an intelligent assistant of the user, which has capabilities of intelligent chat and information processing. In embodiments of the present disclosure, the digital assistant 120 is configured to interact with the user 140 to assist the user 140 in using the terminal device or the business component. An interaction window with the digital assistant 120 may be presented in the client interface. In the interaction window, the user 140 may have a chat with the digital assistant 120 by inputting a natural language, a picture, an audio file, a video file, a web page file, etc., to indicate the digital assistant to assist in completing various tasks, including operations on the content entity 126.

In some embodiments, the digital assistant 120 may be included, as a contact of the user 140, in a contact list of the user 140 in the office suite, or in an information flow of the chat component. In some embodiments, the user 140 has a correspondence with the digital assistant 120. For example, a first digital assistant corresponds to a first user, a second digital assistant corresponds to a second user, and so on. In some embodiments, the first digital assistant may uniquely correspond to the first user, the second digital assistant may uniquely correspond to the second user, and so on. That is, the first digital assistant of the first user may be specific or exclusive to the first user. For example, in the process of the first digital assistant providing assistance or service to the first user, the first digital assistant may utilize historical interaction information between the first digital assistant and the first user, data that is authorized by the first user and accessible by the first digital assistant, a current interaction context between the first digital assistant and the first user, etc. If the first user is an individual or a person, the first digital assistant may be regarded as a personal digital assistant. It would be appreciated that in embodiments of the disclosure, the first digital assistant accesses the data with permission based on the authorization of the first user. It would be appreciated that the “unique correspondence” or similar expressions in the present disclosure are not intended to limit that the first digital assistant will be updated accordingly based on an interaction process between the first user and the first digital assistant. Certainly, depending on actual needs, the digital assistant 120 is not necessarily specific to the current user 140, but may be a general digital assistant.

In some embodiments, a plurality of interaction modes between the user 140 and the digital assistant 120 may be provided, and flexible switching between the plurality of interaction modes is allowed. In the case that a certain interaction mode is triggered, a corresponding interaction region is presented to facilitate the interaction between the user 140 and the digital assistant 120. The manners of interaction between the user 140 and the digital assistant 120 in different interaction modes are different, which may flexibly adapt to interaction requirements in different scenarios.

In some embodiments, an information processing service specific to the user 140 may be provided based on historical interaction information between the user 140 and the digital assistant 120 and/or a data range specific to the user 140. In some embodiments, historical interaction information of the user 140 interacting with the digital assistant 120 in the plurality of interaction modes, respectively, may all be stored in association with the user 140. As such, in one of the plurality of interaction modes (any one or a specified one interaction mode), the digital assistant 120 may provide services for the user 140 based on the historical interaction information stored in association with the user 140.

The digital assistant 120 may be invoked or woken up in an appropriate manner (e.g., via a shortcut key, a button, or speech) to present the interaction window with the user 140. By selecting the digital assistant 120, the interaction window with the digital assistant 120 may be launched. The interaction window may include interface elements for information interaction, such as an input box, a message list, a message bubble, etc. In some other embodiments, the digital assistant 120 may be woken up via an entry control or a menu provided in a page, or may be woken up by inputting a preset instruction.

The interaction window between the digital assistant 120 and the user 140 may include a chat window, for example, a chat window in the instant messaging business component or an instant messaging module of a target business component. In the chat window, the interaction between the digital assistant 120 and the user 140 may be presented in the form of chat messages. Alternatively, or in addition, the interaction window between the digital assistant 120 and the user 140 may further include other types of windows, such as a window in a floating window mode, in which the user 140 may trigger the digital assistant 120 to perform corresponding operations by inputting instructions, selecting quick instructions, etc.

In some embodiments, the digital assistant 120 may support an interaction mode of the chat window, which is also referred to as a chat mode. In this interaction mode, a chat window between the user 140 and the digital assistant 120 is presented, and the user 140 and the digital assistant 120 interact through chat messages in the chat window. In the chat mode, the digital assistant 120 may perform tasks based on the chat messages in the chat window. In the interaction window, the user 140 inputs an interaction message, and the digital assistant 120 provides a reply message in response to the user input.

In some embodiments, the chat mode between the user 140 and the digital assistant 120 may be invoked or woken up in an appropriate manner (e.g., via a shortcut key, a button, or voice) to present the chat window. By selecting the digital assistant 120, the chat window with the digital assistant 120 may be launched. The chat window may include interface elements for information interaction, such as an input box, a message list, a message bubble, etc.

In some embodiments, the digital assistant 120 may support an interaction mode of a floating window (or a floaty window), which is also referred to as a floating window mode. In the case that the floating window mode is triggered, an operation panel (also referred to as a floating window) corresponding to the digital assistant 120 is presented, and the user 140 may issue instructions to the digital assistant 120 based on the operation panel. In some embodiments, the operation panel may include at least one candidate quick instruction. Alternatively, or in addition, the operation panel may include an input control for receiving instructions. In the floating window mode, the digital assistant 120 may perform tasks based on the instructions issued by the user 140 via the operation panel.

In some embodiments, the floating window mode of the user 140 and the digital assistant 120 may also be invoked or woken up in an appropriate manner (e.g., via a shortcut key, a button, or speech) to present the corresponding operation panel. In some embodiments, in a specific business component, for example, the document business component, the digital assistant 120 may be supported to be woken up to provide the interaction in the floating window mode. In some embodiments, in order to trigger the floating window mode to present the operation panel corresponding to the digital assistant 120, an entry control for the digital assistant 120 may be presented in the interface of the business component. In response to detecting a trigger operation on the entry control, it may be determined that the floating window mode is triggered, and the operation panel corresponding to the digital assistant 120 is presented in a target interface region.

In some embodiments described below, for the convenience of discussion, the interaction window between the user and the digital assistant is mainly described as an example of a chat window.

The component running platform 110 may be deployed locally on the terminal device of each user 140, and/or may be supported by a server device. For example, the terminal device of the user 140 may run a client of the component running platform 110, which may support the interaction between the user 140 and the component running platform 110 provided by the server. In the case that the component running platform 110 runs locally on the terminal device of the user, the user 145 may directly interact with the local component running platform 110 by using the terminal device. In the case that the component running platform 110 runs on the server device, the server device may implement service provision to the client running on the terminal device based on a communication connection with the terminal device. The component running platform 110 may present a corresponding interface 150 to the user 140 based on the operation of the user 140, to output to the user 140 and/or receive from the user 140 information related to component usage.

In some embodiments, the implementation of at least some functions of the business component 125 and/or the implementation of at least some functions of the digital assistant 120 may be based on a target model. In the process of running the business component 125, one or more target models 155 may be invoked. The target model 155 may be used to understand the user input, and services such as replies to the user may be provided based on the output of the target model 155.

Although shown as being independent of the component running platform 110, the one or more target models 155 may run on the component running platform 110 or other remote servers. In some embodiments, the target model 155 may be a machine learning model, a deep learning model, a learning model, a neural network, etc.

In some embodiments, the model may be based on a language model (LM). The language model may have the capability of question answering by learning from a large amount of corpus. The target model 155 may also be based on other appropriate models.

The component running platform 110 may run on an appropriate electronic device. The electronic device herein may be any type of device having computing power, including a terminal device or a server device. The terminal device may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a gaming device, or any combination of the foregoing, including the accessories and peripherals of these devices or any combination thereof. The server device may include, for example, a computing system/server, such as a mainframe, an edge computing node, a computing device in a cloud environment, etc. In some embodiments, the component running platform 110 may be implemented based on cloud services.

It would be appreciated that the structure and functions of the environment 100 are described for illustrative purposes only, without suggesting any limitation to the scope of the present disclosure.

As mentioned above, applications may provide people with various services in aspects such as work and life. A work summary function in some applications may organize and manage various information and knowledge to extract items (e.g., projects) that the user has recently focused on. Then, the items may be recommended and presented to the user in the form of cards, which aims to help the user summarize past work, reduce the cost for the user to use the summary function, and enable the user to better take the initiative to use the capability of generating item summaries.

The extraction of the items that the user has recently focused on may enable the user to better use the capability of generating weekly project reports. In order to extract or determine the items (also referred to as projects) that the user is concerned about, a key project recommendation algorithm is needed. The key project recommendation algorithm belongs to a type of content (word) extraction, in which a target entity word is extracted from document data. At present, similar solutions mainly include named entity recognition (abbreviated as NER) technology and keyword extraction technology.

The named entity recognition technology refers to a technology for recognizing entity content with specific meaning in a text. These entities mainly include names of people, place names, time, institutions, proper names, etc. The current main implementation method of the named entity recognition technology is to treat it as a sequence labeling task. A deep semantic model is established for named entity recognition and trained on a large amount of corpus, such as recurrent neural network (RNN)/convolutional neural network (CNN) and conditional random field (CRF)/hidden Markov model (HMM) technologies.

The keyword extraction technology mainly refers to a technology for extracting keywords from an article for use as topic words, tags, etc. At present, most of the mainstream technologies in this regard are developed based on unsupervised algorithms, which may be mainly divided into a method of calculating word weights based on document indicators, a keyword discovery algorithm based on a graph model, and a discovery algorithm based on a topic model. The method of calculating word weights based on document indicators calculates the weight of a word by calculating the linguistic indicators of the word and its statistical features in the document (such as word position information, term frequency-inverse document frequency (TF-IDF) value of the word, part of speech, mutual information, etc.). The higher the weight, the more important the word. The basic idea of the keyword discovery algorithm based on the graph model is to perform word segmentation on the document, take words as nodes, define that there is an edge between two words if they co-occur within a window of a certain length, and take the frequency of co-occurrence as the weight on the edge. In this way, a graph may be formed, and keywords may be discovered by running a correlation analysis algorithm on the graph. The discovery algorithm based on the topic model may obtain the weight distribution of words in a document through a topic model algorithm such as linear discriminant analysis (LDA), thereby obtaining corresponding keywords.

However, project words are different from conventional entity words. Firstly, the project word is not necessarily a named entity, such as an acronym, a technical term, etc. Since the project word covers a relatively large number of word types, it is difficult to perform strict entity distinction and labeling before named entity training. Secondly, the project word is not necessarily a keyword, and a project word may be scattered in various documents but is not the core content in each document. Then, the project word is not necessarily a project that the user himself/herself is concerned about. Multiple project words may appear in the document or work content, but they may not be of most concern to the current user. Therefore, the traditional technology cannot strictly meet the mining requirements of key project words.

In order to solve the above problem, in embodiments of the present disclosure, a solution for item recommendation is proposed. According to various embodiments of the present disclosure, activity information of a target user within a target time period is obtained, the activity information is related to at least one type of interaction activity performed by the target user within the target time period, and a participation degree of the target user in the at least one type of interaction activity satisfies a preset condition. One or more target items associated with the target user are recognized by using a machine learning model based on the activity information and sample information of the at least one type of interaction activity. Recommendation information for the one or more target items is presented.

According to the solution of the present disclosure, the activity information specific to the target user within the target time period may be selected based on the behavior of the target user. In combination with the machine learning model, the items that the target user is concerned about may be recognized, thereby helping the target user quickly review key items. In this way, the user may be helped to improve the efficiency of item processing.

Some example embodiments of the present disclosure will be further described below with reference to the drawings.

FIG. 2 illustrates a flowchart of a method 200 for item recommendation according to some embodiments of the present disclosure. The method 200 may be implemented at the component running platform 110 of FIG. 1. The method 200 will be described with reference to the environment 100 of FIG. 1.

At block 210, the component running platform 110 obtains activity information of a target user within a target time period, the activity information is related to at least one type of interaction activity performed by the target user within the target time period. The activity information here may refer to information that has been subject to pre-processing operations, which may include data filtering, format conversion, data selection, data sorting and other operations. In some embodiments, a participation degree of the target user in the at least one type of interaction activity satisfies a preset condition. Such a preset condition indicates or illustrates that the user is active in the interaction activity. The preset condition may be different depending on the type of the interaction activity. Therefore, the work content that the user is concerned about may be filtered out. The activity information obtained in this way is favorable for the machine learning model to locate the items that the user is concerned about.

In some embodiments, the at least one type of interaction activity may include a chat interaction between the target user and one or more users. For example, the interaction activity may include a private chat between the target user and a user and a group chat between the target user and a plurality of users. The activity information may include all chat interaction records within the target time period. That is, for the interaction activity of the chat type, the preset condition may be that the user participated in the chat activity. If the user is only a member of a certain chat without speaking, such chat information will not be considered. It should be noted that the enabling of functions related to data obtainance, the data obtained, the manner in which the data is processed and stored, etc., in embodiments of the present disclosure shall all be authorized in advance by the user and other rights subjects associated with the user, and shall comply with the provisions of the relevant laws and regulations and agreement rules between the rights subjects.

Alternatively, or in addition, the at least one type of interaction activity may include an editing operation on content by the target user. The content may include various types of content, such as documents, emails, videos, etc. For example, the interaction activity may include editing operations such as addition and deletion of content in a document, format adjustment, paragraph reconstruction, etc. by the target user. The activity information may include a name of the document edited by the target user, the content edited by the target user, and contextual information of the content edited by the target user. For another example, the interaction activity may also include editing of an email by the target user. That is, for the interaction activity related to the content, the preset condition may be that the user edited the content. If the user only browsed certain content without editing it, the information related to the content will not be taken into account. It should be noted that the enabling of functions related to data obtainance, the data obtained, the manner in which the data is processed and stored, etc., in embodiments of the present disclosure shall all be authorized in advance by the user and other rights subjects associated with the user, and shall comply with the provisions of the relevant laws and regulations and agreement rules between the rights subjects.

Alternatively, or in addition, the at least one type of interaction activity may include a real-time interaction scenario that the target user participated in. For example, the interaction activity may include real-time interaction scenarios such as the target user participating in a meeting and/or live streaming. The activity information may include information such as a meeting summary of the meeting and/or a summary of the live streaming that the user participated in. That is, for the real-time interaction scenario, the preset condition may be that the user participated in the real-time interaction scenario. If the user only makes an appointment for a certain real-time interaction scenario or is invited to participate in a certain real-time interaction scenario but does not actually participate, the information about the real-time interaction scenario will not be taken into account. It should be noted that the enabling of functions related to data obtainance, the data obtained, the manner in which the data is processed and stored, etc., in embodiments of the present disclosure shall all be authorized in advance by the user and other rights subjects associated with the user, and shall comply with the provisions of the relevant laws and regulations and agreement rules between the rights subjects.

At block 220, the component running platform 110 recognizes, by using a machine learning model, one or more target items associated with the target user based on the activity information and sample information of the at least one type of interaction activity. The sample information may include an example of the machine learning model outputting a corresponding target item based on the activity information. The key project (also referred to as the target item) that the user focuses on usually appears repeatedly in the daily work information of the user, and therefore the key project word may be recognized by the machine learning model.

In some embodiments, prompt information may be generated based on the activity information and the sample information. The generation of the prompt information will be described below with reference to Table 1, which is an example of the prompt information.

TABLE 1

| | |
|---|---|
| 1 | <work information> |
| 2 | {{ Data }} |
| 3 | </work information> |
| 4 | <user name> |
| 5 | {{ User }} |
| 6 | </user name> |
| 7 | According to the above work information and user name, please: |
| 8 | Only extract project names that are strongly related to the user, |
| | and ignore content unrelated to work. |
| 9 | The project name must be short, no more than 14 characters. |
| 10 | Do not output repeated or semantically similar project words, |
| | and merge project words with an edit distance less than 2. |
| 11 | |
| | Template words such as “meeting minutes”, “meeting name”, “chat |
| | name”, and “document editing” cannot appear in the extracted project |
| | words. |
| 12 | Sort in descending order according to the frequency of |
| | occurrence of the project word (or its synonym) in the user's own |
| | work information. |
| 13 | The formatted output is as follows: |
| 14 | <project word>project word 1,project word 2,project word |
| | 3,project word 4,project word 5</project word> |
| 15 | |
| 16 | |
| 17 | Example: |
| 18 | Input: |
| 19 | <work information> |
| 20 | Li Si and Zhang San discussed the logic problem of pushing and |
| | testing of the daily report. |
| 21 | Zhang San participated in a discussion with Wang Wu on the |
| | comparison of effects of different models and the document |
| | expansion recall project. |
| 22 | In the double-day meeting on the effect optimization of AI |
| | writing daily report, Zhang San suggested limiting the time range of |
| | document summary. |
| 23 | title = Design scheme of document expansion recall |
| 24 | Document content: discussed the design of document expansion |
| | recall. |
| 25 | Zhang San participated in the double-day meeting on effects, |
| | and a plurality of issues including the daily report function were |
| | discussed. |
| 26 | Zhang San edited the document “Improvement of daily report |
| | effect - double-day meeting”, in which the optimization of the daily |
| | report function was discussed. |
| 27 | title = Weekly meeting of Smart answering project in 2024 |
| 28 | Document content: discussed the work objective of the Smart |
| | answering project in May. |
| 29 | Zhang San consulted Zhao Liu about apartment rental. Zhao |
| | Liu said that the room was quiet and formal, and it was perfect |
| | except for the lack of balcony, and sent a photo of the room. |
| 30 | </work information> |
| 31 | Output: |
| 32 | <project word>daily report, document expansion recall, Smart |
| | answering, model effect</project word> |

As shown in Table 1, the content between the start label <work information> and the end label </work informnation> is the activity information, and the content between the start label <project word> and the end label </project word> is the item output by the machine learning model. The content between line 17 and line 32 of Table 1 is sample information for the at least one type of interaction activity, the sample information shows an example of the machine learning model outputting a corresponding target item based on the activity information. The prompt information may be generated based on the activity information and the sample information.

After the prompt information is generated, the component running platform 110 may provide the prompt information to the machine learning model to obtain the output of the machine learning model, and the one or more target items may be determined based on the output. In some embodiments, the one or more target items in the output have a ranking order, and the target item ranking higher is more associated with the target user. In this way, without large-scale labeling behavior, the data mining work may be automatically completed based on the activity information of the target user and the machine learning model.

In some embodiments, initial information generated by the target user performing the at least one type of interaction activity may be obtained, and at least one of filtering or format conversion may be performed on the initial information to obtain the activity information.

In some embodiments, when the initial information is filtered, at least one of the following may be removed: information unrelated to the item to be recognized, or information about an activity that has not started yet. The initial information here may include a summary of the chat interaction records of the target user, a summary and documents of meetings, which may include content unrelated to the work (which may also be referred to as information unrelated to the item to be recognized) and to-do items (which may also be referred to as information about activities that have not started yet), and such initial information is in different formats due to different data sources. Therefore, a filtering operation may be performed on the initial information to filter out the content unrelated to the work and to-do items in order to remove interference items, and unify data from different data sources into activity information in the same format. In this way, the data quality of the activity information may be improved, which is convenient for the machine learning model to understand, thereby improving the accuracy and stability of the output of the machine learning model.

In some embodiments, the sample information may include positive sample information related to the item to be recognized, the positive sample information indicating a first sample of the interaction activity in the at least one type of interaction activity. For example, in the case that the item to be recognized is work, the first sample may be a document, meeting, chat, etc. related to work. In some examples, the first sample may include various usages of the item word. For example, lines 20 to 28 in Table 1 are positive samples. By providing positive sample information to the machine learning model, a clear learning target may be provided for the machine learning model, which is helpful for the machine learning model to learn the correct behavior pattern, and may help the machine learning model optimize its decision boundary so that it may better distinguish between correct and wrong outputs.

Alternatively, or in addition, the sample information may include negative sample information unrelated to the item to be recognized, the negative sample information indicates a second sample of the at least one type of interaction activity. For example, in the case that the item to be recognized is work, the second sample may be noise, such as non-work information content. In the example of Table 1, line 29 is a negative sample. The output information sample in the prompt information (for example, line 32 in Table 1) does not have related words for this part of non-work information of the second sample, so that the machine learning model may be prompted to ignore this part of non-work information. By providing negative sample information to the machine learning model, the discrimination capability of the machine learning model may be improved and the output of these negative samples may be avoided.

In some embodiments, the component running platform 110 may determine, by using the machine learning model, a candidate item set associated with the target user based on the activity information. The machine learning model may determine the candidate item set based on the input activity information and prompt information.

After the candidate item set is determined, the component running platform 110 may update the candidate item set based on respective item names of the candidate items in the candidate item set, and determine the one or more target items based on the updated candidate item set. In some examples, the component running platform 110 may perform a deduplication operation on the candidate item set according to the similarity of the item names.

In some embodiments, in response to determining that an item name of a first candidate item in the candidate item set and an item name of a second candidate item in the candidate item set satisfy a preset similarity condition, the component running platform 110 may merge the first candidate item and the second candidate item into the same item. In some examples, there are items with similar item names in the generated candidate item set, and items that satisfy the preset similarity condition may be merged into the same item.

Alternatively, or in addition, in response to determining that an item name of a third candidate item in the candidate item set and an item name of a subscribed item of the target user satisfy the preset similarity condition, the third candidate item is removed from the candidate item set. In some examples, the item name of the item in the generated candidate item set is similar to the item name of the subscribed item of the target user, and items that meet the preset similarity condition may be merged into the same item. In some examples, the item name of the item in the generated candidate item set is similar to the keyword or alias of the subscribed item of the target user, and items that meet the preset similarity condition may be merged into the same item.

In some embodiments, the preset similarity condition may include that an editing distance between the two compared item names is less than a threshold distance. For example, the threshold distance may be set to 2, and two candidate items with an editing distance between item names less than 2 may be merged.

Alternatively, or in addition, the preset similarity condition may include that the semantic similarity between the two compared item names is larger than a threshold similarity. In some examples, the two item names may be input into a predetermined similarity model to generate the semantic similarity between the two item names. When the semantic similarity between the two item names is larger than the threshold similarity, the two candidate items corresponding to the two item names may be merged.

In some embodiments, the activity information is obtained at a preset time interval, and the time length of the target time period is not less than the time length of the preset time interval. In some examples, the activity information of the target user may be obtained every 3 days (as an example of the preset time interval), and activity information of 5 days (as an example of the target time period) is obtained for each time to recognize one or more target items associated with the target user. In this way, it may be ensured that there is sufficient context for recognizing the target item.

At block 230, the component running platform 110 presents recommendation information for the one or more target items. The component running platform 110 may recommend the one or more target items to the user in a recommendation card.

In some embodiments, the component running platform 110 may determine a first item from the one or more items based on an association degree between the one or more items and the target user. In some examples, the association degree between the one or more target items and the target user may be determined according to the output of the machine learning model, and the higher the ranking of the target item in the output, the higher the association degree with the target user.

After the first item is determined, the component running platform 110 may obtain summary information of the first item within the target time period, and store the summary information for pushing to the target user in response to a viewing instruction for the first item. In some examples, if the target time period is 7 days, a weekly report corresponding to the first item may be generated and pushed to the target user. In this way, the target user may quickly recognize the key project, clarify the progress of the key project, and quickly generate a corresponding weekly report based on it, which saves manpower overhead and improves knowledge management efficiency. Although the pre-generation of the summary is described with reference to a single item, in embodiments of the present disclosure, the summary information of the item may be pre-generated for a plurality of first items.

In some embodiments, the remaining target items other than the first item in the candidate item set may only appear in the recommendation card, and the corresponding summary information is generated only after the target user clicks, so as to avoid interference with the target user.

FIG. 3 illustrates a flowchart of an example process 300 for item recommendation according to some embodiments of the present disclosure. The process 300 may be regarded as an example implementation of the process 200.

As shown in FIG. 3, at block 310, work information (also referred to as activity information) may be obtained. The work information here is the work information of the user, including user chat information, meeting summary, and edited document information. The user chat information may include all chat information of the chat that the user participated in, and may include information about the speaker of each sentence. The meeting summary may include a summary of meetings that the user himself/herself participated in. The edited document information may include the content of the document edited by the user and the context of the edited document content. In the stage of obtaining the work information, filtering is performed based on user behavior operations, etc., for example, only active group chats, edited documents, and participated meetings of the user are obtained. Work information that is weakly related to the user, such as a document with a short reading time, is not obtained, so as to represent the work identity of the user and filter out work content that the user is concerned about. The user work information may be obtained every M days and sent to the machine learning model for recognizing key project words (also referred to as target items) after filtering. The work information of the last N days is obtained each time, and N may be greater than M. In this way, in the case that the data of M days is relatively small, obtaining the data of N days may ensure sufficient contextual information.

At block 320, data pre-processing may be performed. The data pre-processing includes performing data filtering operation, unified format operation, etc. on the above work information. The data filtering operation is to filter out the content unrelated to work and to-do items in order to remove interference items. The unified format operation is to unify data from different data sources into the same format, which is convenient for the machine learning model to understand the input data.

At block 330, project extraction may be performed. The pre-processed work information is input into the machine learning model, and the output of the machine learning model may be obtained. The output may include one or more project keywords.

At block 340, deduplication may be performed on the extracted project. In some examples, deduplication may be performed between generated key project words. In some examples, deduplication may be performed between the generated project word and the key project word that the user has subscribed to. In addition, keywords or aliases of the project word may also be extracted from the weekly report generated by the key project word subscribed by the user, and the keywords or aliases may be used to assist the deduplication operation between the generated project word and the key project word subscribed by the user.

At block 350, the key project word after deduplication is saved and pushed on a regular basis. For the key project word that is highly associated with the user, a corresponding weekly report may be generated for the user by default. The key project word with high user association may be the key project word actively subscribed by the user or the top project word in the output of the machine learning model. The remaining project words (for example, with relatively low confidence) may only appear in the recommendation card. The corresponding weekly report is generated only after the user clicks to avoid interference with the user.

### Example Apparatus and Device

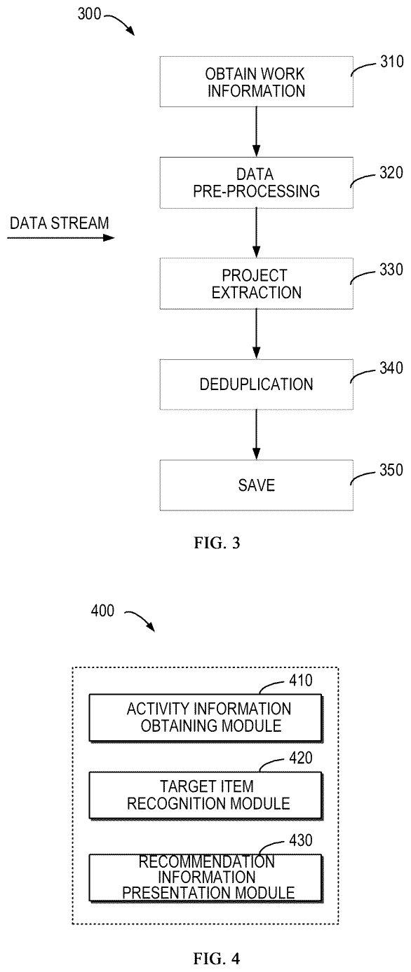

FIG. 4 illustrates a schematic structural block diagram of an apparatus 400 for item recommendation according to some embodiments of the present disclosure. The apparatus 400 may be implemented as or included in the component running platform 110. Each module/component in the apparatus 400 may be implemented by hardware, software, firmware, or any combination thereof.

As shown in FIG. 4, the apparatus 400 includes an activity information obtaining module 410 configured to obtain activity information of a target user within a target time period, the activity information being related to at least one type of interaction activity performed by the target user within the target time period, and a participation degree of the target user in the at least one type of interaction activity satisfying a preset condition. The apparatus 400 further includes a target item recognition module 420 configured to recognize one or more target items associated with the target user by using a machine learning model and based on the activity information and sample information of the at least one type of interaction activity. The apparatus 400 further includes a recommendation information presenting module 430 configured to present recommendation information about the one or more target items.

In some embodiments, the target item recognition module 420 is further configured to generate prompt information based on the activity information and the sample information; the prompt information to the machine learning model to obtain a output of the machine learning model; and determine the one or more target items based on the output.

In some embodiments, the sample information includes at least one of: positive sample information indicating a first sample of an interaction activity in the at least one type of interaction activity, the first sample related to a first item, or negative sample information indicating a second sample of an interaction activity in the at least one type of interaction activity, the second sample unrelated to the first item.

In some embodiments, the at least one type of interaction activity includes at least one of: a chat interaction between the target user and one or more users, an editing operation for content by the target user, or a real-time interaction scenario participated in by the target user.

In some embodiments, the target item recognition module 420 is further configured to determine, by using the machine learning model, a candidate item set associated with the target user based on the activity information; update the candidate item set based on a respective item name of a candidate item in the candidate item set; and determine the one or more target items based on the updated candidate item set.

In some embodiments, the target item recognition module 420 is further configured to merge, in response to determining that an item name of a first candidate item in the candidate item set and an item name of a second candidate item in the candidate item set satisfy a preset similarity condition, the first candidate item and the second candidate item into a same item, or remove, in response to determining that an item name of a third candidate item in the candidate item set and an item name of a subscribed item of the target user satisfy the preset similarity condition, the third candidate item from the candidate item set.

In some embodiments, the preset similarity condition includes at least one of: an editing distance between two compared item names is less than a threshold distance, or a semantic similarity between the two compared item names is larger than a threshold similarity.

In some embodiments, the activity information is obtained according to a preset time interval, and a time length of the target time period is not less than a time length of the preset time interval.

In some embodiments, the apparatus 400 further includes a pushing module configured to determine a first item from the one or more target items based on an association degree between the one or more target items and the target user; obtain summary information of the first item within the target time period; and store the summary information for pushing to the target user in response to a viewing instruction for the first item.

In some embodiments, the activity information obtaining module 410 is further configured to obtain initial information generated by the target user performing the at least one type of interaction activity; and perform at least one of filtering or format conversion for the initial information to obtain the activity information.

In some embodiments, the activity information obtaining module 410 is further configured to remove at least one of the following from the initial information: information unrelated to an item to be recognized, or information about an activity that has not started yet.

The units and/or modules included in the apparatus 400 may be implemented in various ways, including software, hardware, firmware, or any combination thereof. In some embodiments, one or more units and/or modules may be implemented using software and/or firmware, such as machine executable instructions stored on a storage medium. In addition to machine executable instructions or as an alternative, some or all units and/or modules in the apparatus 400 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), and more.

It would be appreciated that one or more steps in the above methods may be performed by an appropriate electronic device or combination of electronic devices. Such electronic device or combination of electronic devices may include, for example, the component running platform 110 in FIG. 1.

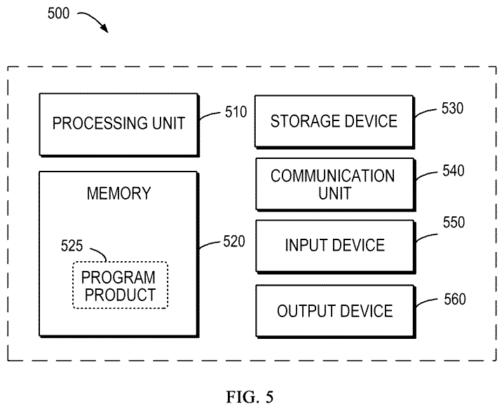

FIG. 5 illustrates a block diagram of an electronic device 500 in which one or more embodiments of the present disclosure may be implemented. It would be appreciated that the electronic device 500 shown in FIG. 5 is only illustrative and should not constitute any limitation to the functions and scope of the embodiments described herein. The electronic device 500 shown in FIG. 5 may be used to implement the component running platform 110 of FIG. 1.

As shown in FIG. 5, the electronic device 500 is in the form of a general electronic device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and may perform various processes based on the programs stored in the memory 520. In a multi-processor system, multiple processing units execute computer executable instructions in parallel to improve the parallel processing capability of the electronic device 500.

The electronic device 500 typically includes multiple computer storage medium. Such medium may be any available medium that is accessible to the electronic device 500, including but not limited to volatile and non-volatile medium, and removable and non-removable medium. The memory 520 may be volatile memory (e.g., a register, cache, a random access memory (RAM)), a non-volatile memory (such as a read-only memory (ROM), an electrically erasable programmable read-only memory (EEPROM), a flash memory), or any combination thereof.

The storage device 530 may be any removable or non-removable medium, and may include a machine-readable medium such as a flash drive, a disk, or any other medium, which may be used to store information and/or data and may be accessed within the electronic device 500.

The electronic device 500 may further include additional removable/non-removable, volatile/non-volatile memory medium. Although not shown in FIG. 5, a disk driver for reading from or writing to a removable, non-volatile disk (e.g., a “floppy disk”), and an optical disk driver for reading from or writing to are movable, non-volatile optical disk may be provided. In these cases, each driver may be connected to the bus (not shown) by one or more data medium interfaces. The memory 520 may include a computer program product 525 having one or more program modules configured to perform various methods or acts of the various embodiments of the present disclosure.

The communication unit 540 implements communication with other electronic devices through the communication medium. Additionally, the functions of the components of the electronic device 500 may be implemented by a single computing cluster or multiple computing machines, which may communicate via communication connections. Therefore, the electronic device 500 may use a logical connection with one or more other servers, a network personal computer (PC), or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may also communicate with one or more external devices (not shown) as needed through the communication unit 540, the external devices such as a storage device, a display device, etc., communicate with one or more devices that enable the user to interact with the electronic device 500, or communicate with any devices (e.g., a network card, a modem, etc.) that enable the electronic device 500 to communicate with one or more other electronic devices. Such communication may be performed via input/output (I/O) interfaces (not shown).

According to an illustrative implementation of the present disclosure, there is provided a computer-readable storage medium having computer executable instructions stored thereon, where the computer executable instructions are executed by a processor to implement the method described above. According to an illustrative implementation of the present disclosure, there is further provided a computer program product tangibly stored on a non-transitory computer-readable medium and including computer executable instructions, which are executed by a processor to implement the method described above.

Aspects of the present disclosure are described herein with reference to flowcharts and/or block diagrams of methods, apparatuses, devices, and computer program products implemented according to the present disclosure. It would be appreciated that each block of the flowcharts and/or block diagrams, and combinations of blocks in the flowcharts and/or block diagrams, may be implemented by computer-readable program instructions.

These computer-readable program instructions may be provided to a processing unit of a general-purpose computer, a special-purpose computer, or other programmable data processing apparatus to produce a machine, such that when the instructions are executed by the processing unit of the computer or other programmable data processing apparatus, an apparatus for implementing the functions/acts specified in one or more blocks of the flowcharts and/or block diagrams is produced. These computer-readable program instructions may also be stored in a computer-readable storage medium, which instructions cause the computer, the programmable data processing apparatus, and/or other devices to work in a particular manner, and thus, the computer-readable medium having the instructions stored therein includes an article of manufacture including instructions for implementing various aspects of the functions/acts specified in one or more blocks of the flowcharts and/or block diagrams.

The computer-readable program instructions may be loaded onto a computer, another programmable data processing apparatus, or other devices, such that a series of operational steps are performed on the computer, the another programmable data processing apparatus, or other devices to produce a computer-implemented process, thereby causing the instructions executed on the computer, the another programmable data processing apparatus, or other devices to implement the functions/acts specified in one or more blocks of the flowcharts and/or block diagrams.

The flowcharts and block diagrams in the drawings show the possibly implemented architectures, functions, and operations of the system, method, and computer program product according to multiple implementations of the present disclosure. In this regard, each block in the flowchart or block diagram may represent a module, program segment, or part of instruction, which module, program segment, or part of instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It would also be noted that each block of the block diagrams and/or flowcharts, and combinations of the blocks in the block diagrams and/or flowcharts, may be implemented by a special-purpose hardware-based system that perform the specified functions or acts, or may be implemented by a combination of special-purpose hardware and computer instructions.

The implementations of the present disclosure have been described above, and the above description is illustrative, non-exhaustive, and not limited to the disclosed implementations. Many modifications and variations will be apparent to those of ordinary skill in the art without departing from the scope of the described implementations. The choice of terms used herein is intended to best explain the principles of the implementations, the practical applications, or improvements to the technology in the market, or to enable other persons of ordinary skill in the art to understand the implementations disclosed herein.

1. A method for item recommendation, comprising:
obtaining activity information of a target user within a target time period, the activity information being related to at least one type of interaction activity performed by the target user within the target time period, and a participation degree of the target user in the at least one type of interaction activity satisfying a preset condition;
recognizing, by using a machine learning model, one or more target items associated with the target user based on the activity information and sample information of the at least one type of interaction activity; and
presenting recommendation information about the one or more target items.

2. The method of claim 1, wherein recognizing the one or more target items associated with the target user comprises:
generating prompt information based on the activity information and the sample information;
providing the prompt information to the machine learning model to obtain a output of the machine learning model; and
determining the one or more target items based on the output.

3. The method of claim 2, wherein the sample information comprises at least one of:
positive sample information indicating a first sample of an interaction activity in the at least one type of interaction activity, the first sample related to a first item, or
negative sample information indicating a second sample of an interaction activity in the at least one type of interaction activity, the second sample unrelated to the first item.

4. The method of claim 1, wherein recognizing the one or more target items associated with the target user within the target time period comprises:
determining, by using the machine learning model, a candidate item set associated with the target user based on the activity information;
updating the candidate item set based on a respective item name of a candidate item in the candidate item set; and
determining the one or more target items based on the updated candidate item set.

5. The method of claim 4, wherein updating the candidate item set comprises at least one of:
merging, in response to determining that an item name of a first candidate item in the candidate item set and an item name of a second candidate item in the candidate item set satisfy a preset similarity condition, the first candidate item and the second candidate item into a same item, or
removing, in response to determining that an item name of a third candidate item in the candidate item set and an item name of a subscribed item of the target user satisfy the preset similarity condition, the third candidate item from the candidate item set.

6. The method of claim 5, wherein the preset similarity condition comprises at least one of:
an editing distance between two compared item names being less than a threshold distance, or
a semantic similarity between the two compared item names being larger than a threshold similarity.

7. The method of claim 1, wherein the activity information is obtained according to a preset time interval, and a time length of the target time period is not less than a time length of the preset time interval.

8. The method of claim 1, further comprising:
determining a first item from the one or more target items based on an association degree between the one or more target items and the target user;
obtaining summary information of the first item within the target time period; and
storing the summary information for pushing to the target user in response to a viewing instruction for the first item.

9. The method of claim 1, wherein obtaining the activity information comprises:
obtaining initial information generated by the target user performing the at least one type of interaction activity; and
performing at least one of filtering or format conversion for the initial information to obtain the activity information.

10. The method of claim 9, wherein performing filtering on the initial information comprises removing at least one of the following from the initial information:
information unrelated to a first item, or
information about an activity that has not started yet.

11. The method of claim 1, wherein the at least one type of interaction activity comprises at least one of:
a chat interaction between the target user and one or more users,
an editing operation for content by the target user, or
a real-time interaction scenario participated in by the target user.

12. An electronic device, comprising:
at least one processor; and
at least one memory, the at least one memory being coupled to the at least one processor and storing instructions executable by the at least one processor, the instructions, when executed by the at least one processor, causing the electronic device to perform acts comprising:
obtaining activity information of a target user within a target time period, the activity information being related to at least one type of interaction activity performed by the target user within the target time period, and a participation degree of the target user in the at least one type of interaction activity satisfying a preset condition;
recognizing, by using a machine learning model, one or more target items associated with the target user based on the activity information and sample information of the at least one type of interaction activity; and
presenting recommendation information about the one or more target items.

13. The electronic device of claim 12, wherein recognizing the one or more target items associated with the target user comprises:
generating prompt information based on the activity information and the sample information;
providing the prompt information to the machine learning model to obtain a output of the machine learning model; and
determining the one or more target items based on the output.

14. The electronic device of claim 13, wherein the sample information comprises at least one of:
positive sample information indicating a first sample of an interaction activity in the at least one type of interaction activity, the first sample related to a first item, or
negative sample information indicating a second sample of an interaction activity in the at least one type of interaction activity, the second sample unrelated to the first item.

15. The electronic device of claim 12, wherein recognizing the one or more target items associated with the target user within the target time period comprises:
determining, by using the machine learning model, a candidate item set associated with the target user based on the activity information;
updating the candidate item set based on a respective item name of a candidate item in the candidate item set; and
determining the one or more target items based on the updated candidate item set.

16. The electronic device of claim 15, wherein updating the candidate item set comprises at least one of:
merging, in response to determining that an item name of a first candidate item in the candidate item set and an item name of a second candidate item in the candidate item set satisfy a preset similarity condition, the first candidate item and the second candidate item into a same item, or
removing, in response to determining that an item name of a third candidate item in the candidate item set and an item name of a subscribed item of the target user satisfy the preset similarity condition, the third candidate item from the candidate item set.

17. The electronic device of claim 16, wherein the preset similarity condition comprises at least one of:
an editing distance between two compared item names being less than a threshold distance, or
a semantic similarity between the two compared item names being larger than a threshold similarity.

18. The electronic device of claim 12, wherein the activity information is obtained according to a preset time interval, and a time length of the target time period is not less than a time length of the preset time interval.

19. The electronic device of claim 12, wherein the acts further comprise:
determining a first item from the one or more target items based on an association degree between the one or more target items and the target user;
obtaining summary information of the first item within the target time period; and
storing the summary information for pushing to the target user in response to a viewing instruction for the first item.

20. A non-transitory computer-readable storage medium having a computer program stored thereon, the computer program being executable by a processor to implement acts comprising:
obtaining activity information of a target user within a target time period, the activity information being related to at least one type of interaction activity performed by the target user within the target time period, and a participation degree of the target user in the at least one type of interaction activity satisfying a preset condition;
recognizing, by using a machine learning model, one or more target items associated with the target user based on the activity information and sample information of the at least one type of interaction activity; and
presenting recommendation information about the one or more target items.
